(19) United States
(12) Patent Application Publication
(10) Pub. No.: US 2007/0024186 A1
(43) Pub. Date: Feb. 1, 2007

(54) Color Filter Conversion Apparatus and an Organic Electroluminescent Display Apparatus Thereof

(75) Inventors: Ting-Chou Chen, Chu Nan (TW); Wen-Jeng Lan, Chu Nan (TW); Chih-Ming Chin, Chu Nan (TW); Joel Chia-Yeh Chang, Chu Nan (TW); Chien-Chih Chiang, Chu Nan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: UNIVISION TECHNOLOGY, INC, Chu Nan (TW)

(21) Appl. No.: 11/460,272

(22) Filed: Jul. 27, 2006

(30) Foreign Application Priority Data
Jul. 28, 2005 (TW) 94125673

(51) Int. Cl. H01J 1/62; H01J 63/04

(52) U.S. Cl. 313/504

(57) ABSTRACT

The present invention relates to a color filter conversion apparatus. More particularly, the present invention relates to a color filter conversion apparatus and the application thereof. A color conversion layer, a first photo resist, and a second photo resist are arranged on the substrate. In addition, a first organic light emitting element is arranged on the vertically extended region of the second photo resist and a second organic light emitting element is arranged on the vertically extended region of the first photo resist, the second photo resist and the color conversion layer. Thus, the times for evaporating processes are decreased. Furthermore, the transmittance through the photo resist for the light source produced by the organic light emitting element is raised and the converting efficiency of the color conversion layer can also be enhanced.

### RELATED APPLICATIONS

The present application is based on, and claims priority from, Taiwan Application Serial Number 94125673, filed Jul. 28, 2005, the disclosure of which is hereby incorporated by reference herein in its entirety.

### BACKGROUND

1. Field of Invention

The present invention relates to a color filter conversion apparatus. More particularly, the present invention relates to a color filter conversion apparatus and an organic light emitting diode (OLED) display apparatus thereof.

2. Description of Related Art

The key point of successfully developing a display apparatus is how to achieve full-color technology. In terms of OLED, there three common ways to achieve full-color:

1. Emission of three primary colors by independent pixel: the OLED devices of three primary colors (red, green, and blue) are positioned side by side. In addition, the lights of these three colors are mixed with appropriate ratio to obtain full-color effect.

However, an organic electroluminescent display apparatus needs to be processed by evaporating and masking several times to produce different color OLED devices. Thus, the manufacturing process is complicated. In addition to that, the accuracy of alignment required by evaporating and masking processes has to be very high so lower yield rate and more cost are expected.

2. Color conversion: A color change media (CCM) is excited by using a blue OLED device as the light source to obtain three primary visible lights, red, green, and blue. Therefore, full-color effect can be obtained.

However, the energy difference between the blue light source and red light is large, so the efficiency is low while converting the blue light source into the red one, which affects the brightness of OLED.

3. Color filter: at least one OLED device which emits white light is installed as a back light source. By using the well developed color filter technique, the white light source can be filtered by the color filter to obtain full-color effect.

FIG. 1 illustrates the common structure of an organic electroluminescent display apparatus for light filtering by color filter. Color filter 10 comprises a black matrix 13 arranged on a substrate 11 and a color filter layer 15 disposed on substrate 11 where no black matrix 13 is arranged on. The color filter layer 15 comprises a first photo resist 151, a second photo resist 153, and a third photo resist 155. In addition, a flat barrier element 17, which is selected as an overcoat layer or a barrier layer, is arranged above the black matrix 13 and the color filter layer 15 to make the further process more easily.

Besides, a first electrode 21 of an OLED device 20 is arranged on the flat barrier element 17. An organic light emitting element 23 and a second electrode 25 are placed on the first electrode 21 in sequence. The organic light emitting element 23 projects a white light source S by conducting a working current between the first electrode 21 and the second electrode 25. After transmitting through the color filter layer 15, the white light source S will be filtered and become three primary lights, green (L1), blue (L2), and red (L3) respectively. By arranging and combining these three primary colors, full-color display of organic electroluminescent display apparatus 200 can be obtained.

By using color filter 10, the organic electroluminescent display apparatus 200 only requires an organic light emitting element 23 to produce white light source S. Therefore, it requires fewer evaporating processes, and also avoids the difficulty of accurate alignment while evaporating or masking. However, because the wavelength of the white light source S ranges widely, the transmittance through the color filter layer 15 is low. This affects the brightness and the saturation of the organic electroluminescent display apparatus 200, therefore, the quality of emitting can not be enhanced efficiently.

### SUMMARY

For the forgoing reasons, the present invention relates to a new color filter conversion apparatus and an organic electroluminescent display apparatus thereof. This not only avoids the difficulties of evaporating and alignment but also enhances yield rate and transmittance of the photo resist of the light source.

It is therefore an objective of the present invention to provide a color filter conversion apparatus. A color conversion layer and a photo resist are arranged on the substrate to filter and convert the light from the light source. Thus, the number of times for evaporating the OLED light emitting element is decreased and the efficiency of manufacturing the organic electroluminescent display apparatus is increased.

It is another objective of the present invention to provide a color filter conversion apparatus. The color conversion layer is disposed on one of sub pixels of a single pixel to reduce the cost of the color conversion layer.

It is still another objective of the present invention to provide a color filter conversion apparatus and an organic electroluminescent display apparatus thereof. The light generated by the organic light emitting element with better light emitting efficiency can be converted by a color conversion layer, whereby the lifetime of the organic electroluminescent display apparatus will be prolonged.

It is another objective of the present invention to provide a color filter conversion apparatus and an organic electroluminescent display apparatus thereof. The energy difference between the light source and the converted light is small, whereby it can enhance the lifetime and the converting efficiency of the color conversion layer.

In accordance with the foregoing and other objectives of the present invention, an organic electroluminescent display apparatus is provided, which comprise: a substrate; a first color filter conversion apparatus comprising at least one color conversion layer arranged on the substrate, and at least one first photo resist and at least one second photo resist arranged on the substrate where no color conversion layer is arranged on; a first electrode arranged on the first color filter conversion apparatus; an organic light emitting element arranged on the first electrode; and an second electrode arranged on the organic light emitting element.

In accordance with the foregoing and other objectives of the present invention, a color filter conversion apparatus is provided, which comprise: a substrate; at least one color conversion layer, arranged on the substrate; and at least one first photo resist and at least second photo resist, arranged on the substrate where no the color conversion layer is arranged on.

Furthermore, an organic electroluminescent display apparatus is also provided, which comprises: a substrate; at least one organic light emitting element arranged on the substrate; a packing cover arranged on the substrate, and the packing cover encloses the organic light emitting element; a second color filter conversion apparatus, comprising at least one color conversion layer arranged at the bottom of the packing cover, and at least one first photo resist and at least one second photo resist arranged on the substrate where no color conversion layer is arranged; a first electrode arranged on the substrate and underneath the organic light emitting element; and an second electrode arranged on the organic light emitting element.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a cross-section prospective view of an organic electroluminescent display apparatus in the prior art;

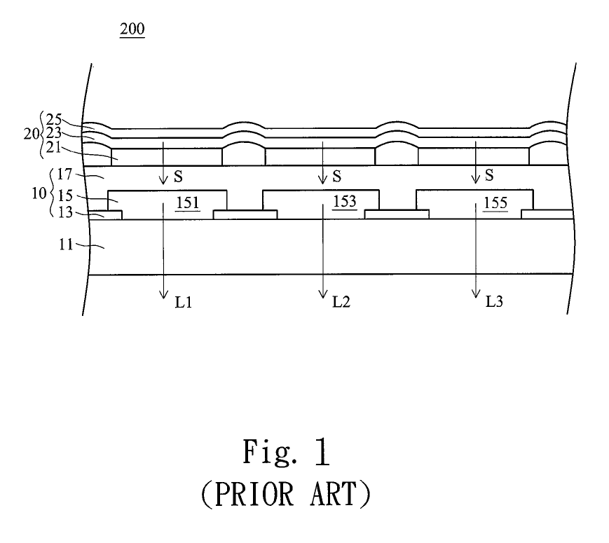

FIG. 2 is the cross-section prospective view of a color filter conversion apparatus and an organic electroluminescent display apparatus thereof, according to one preferred embodiment of this invention;

FIG. 3 is the cross-section prospective view of an embodiment of this invention;

FIG. 4 is the cross-section prospective view of an embodiment of this invention;

FIG. 5 is the cross-section prospective view of an embodiment of this invention;

FIG. 6 is the cross-section prospective view of an active-matrix organic electroluminescent display apparatus of an embodiment of this invention; and

FIG. 7 is the cross-section prospective view of an embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

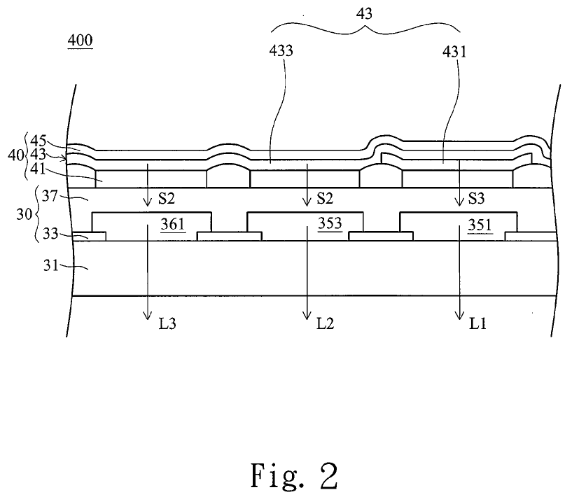

According to FIG. 2, it illustrates the cross-section prospective view of one preferred embodiment of the present invention, which shows a color filter conversion apparatus and an organic electroluminescent display apparatus thereof. As shown in FIG. 2, a first color filter conversion apparatus 30 comprises at least one black matrix 33 arranged on a substrate 31. A color conversion layer 361 is formed on the black matrix 33 and on the substrate 31 where no black matrix 33 is arranged on. Other place of the substrate 31 where no the color conversion layer 361 is placed on are arranged with a first photo resist 351 and a second photo resist 353. In addition, above the black matrix 33, color conversion layer 361, the first photo resist 351 and the second photo resist 353 are covered with a flat barrier element 37 such as an overcoat and/ or barrier layer. It benefits for arranging an OLED device 40 by forming the flat barrier element 37.

At least one first electrode 41 of the OLED device 40 is arranged on the flat barrier element 37 of the first color filter conversion apparatus 30. In addition, an organic light emitting element 43 and an second electrode 45 are arranged on the first electrode 41 in sequence, wherein the organic light emitting element 43 comprises at least one first organic light emitting element 431 and at least one second organic light emitting element 433. Moreover, the first organic light emitting element 431 is disposed on the vertically extended region of the first photo resist 351. The second organic light emitting element 433 is disposed on the vertically extended region of the first photo resist 351, the second photo resist 353, and the color conversion layer 361. Thus, the overlap between the first organic light emitting element 431 and the second organic light emitting element 433 is formed on the vertically extended region of the first photo resist 351.

Moreover, while providing a working current between the first electrode 41 and the second electrode 45, the second organic light emitting element 433 will produce a second light source S2, and the overlap between the first organic light emitting element 431 and the second organic light emitting element 433 produces a third light source S3. After transmitting through the second photo resist 353, the light from the second light source S2 will be filtered to produce a second light L2, and the light from the second light source S2 will be converted into a third light L3 after transmitting through the color conversion layer 361. The light from the third light source S3 will be filtered to form a first light L1, after transmitting through the first photo resist 351. By mixing the first light L1, the second light L2, and the third light L3 with an appropriate ratio, the organic electroluminescent display apparatus 400 can obtain full-color effect.

In practice, the second light source S2 and the third light source S3 are green light source and blue-green light source respectively. Moreover, the first photo resist 351 and the second photo resist 353 are blue photo resist and green photo resist respectively. Therefore, after light transmitting through the second photo resist 353 (green) and the first photo resist 351 (blue), the light from the second light source S2 (green light source) and the third light source S3 (blue-green light source) will be filtered respectively, and then the second light L2 (green light) and the first light L1 (blue light) will be generated.

The light from the second light source S2 will be converted into a third light L3 (red light) after it is transmitting through the color conversion layer 361. Thus, the color conversion layer 361 is selected as a color conversion layer that coverts the green light source into a red one.

Since both the second light source S2 (green light source) and the third light source S3 (blue-green light source) generate light with better transmittance compared with the light from the white light source S constructed in the art, this enhances the brightness of the organic electroluminescent display apparatus 400 more efficiently. Furthermore, the color conversion layer 361 converts the light from the second light source S2 (green light source) into the third light L3 (red light). Since the differences of the wavelength and the energy between the light from the second light source S2 (green light source) and the third light L3 (red light) are smaller than Color Change Media in the prior art, this can increase the converting efficiency from the second light source S2 (green light source) and the third light L3 (red light).

In the matter of brightness and lifetime, there is a great difference between the OLED device used for generating red light from the OLED device 40 in the art and other OLED devices. Thus, the brightness of the red light will not be enough, which is unfavorable for the display of the organic electroluminescent display apparatus 400. Instead of using an OLED device to produce red light, the red light can be emitted and the organic electroluminescent display apparatus 400 can have full-color display by using the color conversion layer 361. Hence, the lifetime of the organic electroluminescent display apparatus 400 can be increased a lot.

Moreover, in the embodiment of the present invention above, the positions of the first organic light emitting element 431 and the second organic light emitting element 433 are exchangeable. For example, the second organic light emitting element 433 is disposed first, and then the first organic light emitting element 431 is arranged on the second organic light emitting element 433.

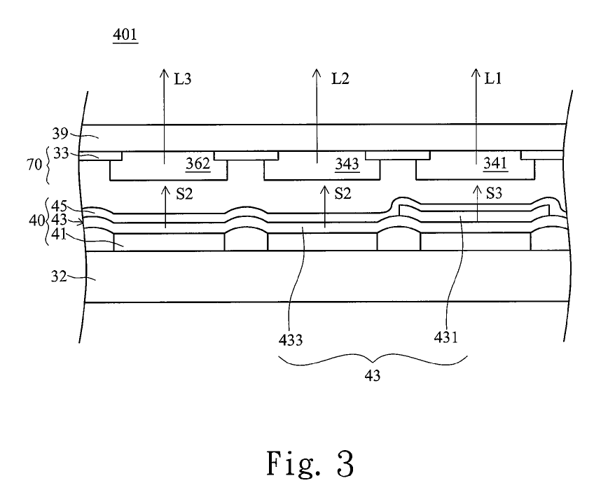

Referring to FIG. 3, it illustrates a cross-section prospective view of another embodiment of the present invention. As shown in FIG. 3, the organic electroluminescent display apparatus 401 comprises the first organic light emitting element 431 and the second organic light emitting element 433 disposed on the substrate 32. In addition to that, there is a packing cover 39 arranged on the substrate 32. Moreover, the first organic light emitting element 341 and the second organic light emitting element 433 are enclosed by the packing cover 39. Underneath the packing cover 39, there is a second color filter conversion apparatus 70 arranged on, which comprises the first photo resist 341, the second photo resist 343, and the color conversion layer 362. Thus, the organic electroluminescent display apparatus 401 is top emission.

Furthermore, the second organic light emitting element 433 is disposed on the vertically extended region of the first photo resist 341, the second photo resist 343, and the color conversion layer 362. The first organic light emitting element 431 is arranged on the vertically extended region of the first photo resist 341 and also on the second organic light emitting element 433. Again, in another embodiment of the present invention, the substrate 32 can be a first color filter conversion apparatus 30, so the OLED will be double-emitting.

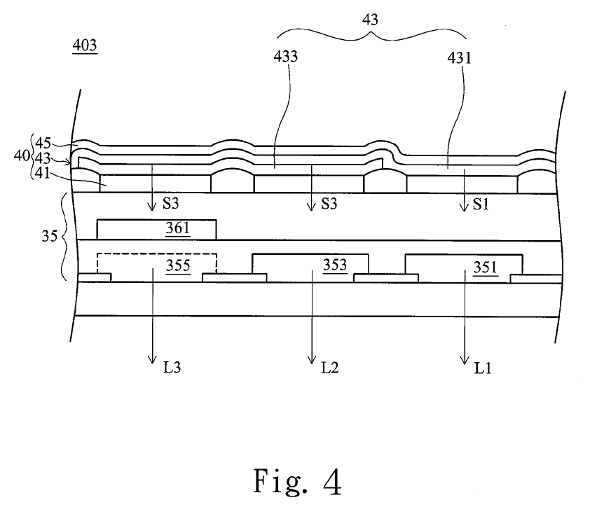

Next, referring to FIG. 4, it depicts the cross-section prospective view of another embodiment of the present invention. The organic electroluminescent display apparatus 403 comprises a color conversion layer 361 arranged on the color filter 35. For example, the color conversion layer 361 is formed on the vertically extended region of the third photo resist 355 of the color filter 35 to filter and convert light. Certainly, the area for arranging the third photo resist 355 can also be a hallow area or a transparent area, instead of the third photo resist 355.

The OLED device 40 can be formed on the color filter 35 and also on the color conversion layer 361. In addition to that, the second organic light emitting element 433 is disposed on the vertically extended region of the second photo resist 353 and the third photo resist 355 (color conversion layer 361). The first organic light emitting element 431 is disposed on the vertically extended region of the first photo resist 351, the second photo resist 353, and the third photo resist 355 (color conversion layer 361), whereby the overlap between the first organic light emitting element 431 and the second light emitting element 433 is formed on the vertically extended region of the second photo resist 353, and the third photo resist 355 (color conversion layer 361).

The overlap between the first organic light emitting element 431 and the second light emitting element 433 is for producing a third light source S3. Parts of the third light source S3 pass through the color conversion layer 361 and then the third photo resist 355 in sequence. Therefore, the light from the third light source S3 will be converted and then filtered to generate a third light L3. For example, the third light source S3 is a blue-green light source and the third light L3 is a red light.

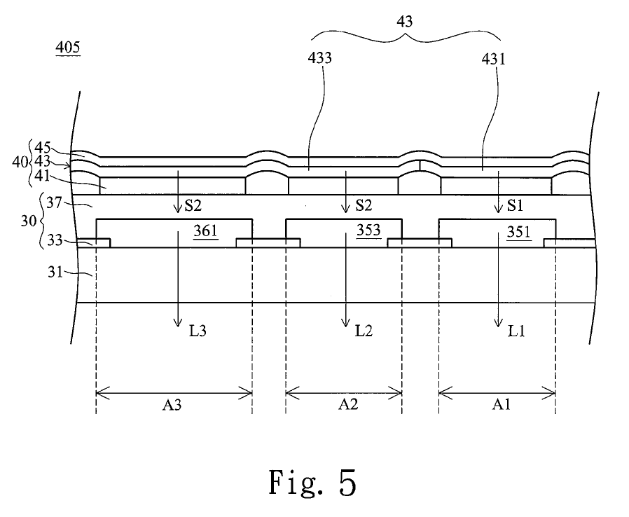

In addition to that, the FIG. 5 illustrates the cross-section prospective view of another embodiment of the present invention. There are the first organic light emitting element 431 and the second light emitting element 433 arranged on the first color filter conversion apparatus 30 of the organic electroluminescent display apparatus 405. A functional area A3 of the color conversion layer 361 is larger than functional areas of the first photo resist 351, A1, or the second photo resist 353, A2.

In the embodiment of the present invention, the second organic light emitting element 433 is arranged on the vertically extended region of the color conversion layer 361 and the second photo resist 353. The first organic light emitting element 431 is arranged on the vertically extended region of the first photo resist 351. Moreover, to avoid the color conversion layer 361 inefficiently converting the second light source S2 produced by the second organic light emitting element 433, the functional area A3 of the color conversion layer 361 can be larger than the functional areas of the first photo resist 351 and the second photo resist 353, A1 and A2, when arranging the color conversion layer 361. This will enhance the brightness of the third light L3 and also maintain the uniformity of the brightness between the first light L1, the second light L2 and the third light L3.

In practice, according to the difference of brightness between the first light L1 and the second light L2, the functional areas of the first photo resist 351 and the second photo resist 353 can be adjusted. For example, when the emitting efficiency of the second organic light emitting element 433 is better than the first organic light emitting element 431, the brightness of the second light L2 will higher than the first light L1. Thus, the functional area A1 of the first photo resist 351 can be larger than the functional area A2 of the second photo resist 353.

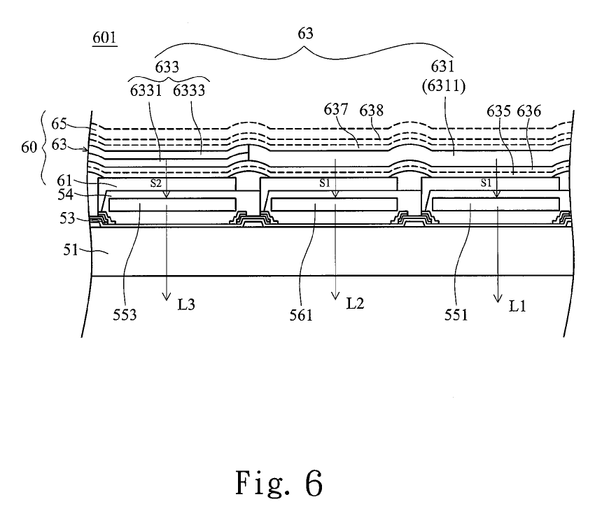

As shown in FIG. 6, it illustrates the cross-section prospective view of another embodiment of the present invention. An organic electroluminescent display apparatus of the present invention can be an active-matrix organic electroluminescent display apparatus 601. At least one thin film transistor (TFT) 53 is arranged on a substrate 51. In addition, the substrate 51 and the TFT 53 is covered by an insulating layer 54, wherein there are at least one first photo resist 551, a second photo resist 553, and a color conversion layer 561 arranged in the insulating layer 54. Moreover, there is at least one first electrode 61 positioned on the insulating layer 54, and the first electrode 61 electrically connects with the corresponding TFT 53. At least one organic light emitting element 63 is arranged on the first electrode 61, which form an active-matrix organic electroluminescent display apparatus of a color filter on array (COA).

Furthermore, to arrange the organic light emitting element 63, the first organic light emitting element 631 and the second organic light emitting element 633 are formed on the first electrode 61. The first organic light emitting element 631 is formed on the vertically extended region of the first photo resist 551 and the color conversion layer 561. The second organic light emitting element 633 is arranged on the vertically extended region of the second photo resist 553. In addition to that, the inside of the first organic light emitting element 631 and the second light emitting element 633 can optionally comprise a hole injection layer (HIL) 635, a hole transporting layer (HTL) 636, an organic light emitting layer 63, an electron transporting layer (ETL) 637, and an electron injection layer (EIL) 638. The second electrode 65 is positioned on the electron injection layer 638.

The organic light emitting element 63 (the first organic light emitting element 631 or the second organic light emitting element 633) optionally comprises a single-layer organic light emitting layer or multi-layer overlapping organic light emitting layer. For example, the first organic light emitting element 631 can be a single-layer organic light emitting layer wherein there is a first organic light emitting layer 6311 inside. However, the second organic light emitting element 633 can be a multi-layer overlapping organic light emitting layer, wherein there are a second organic light emitting layer 6331 and a third light emitting layer 6333 in it.

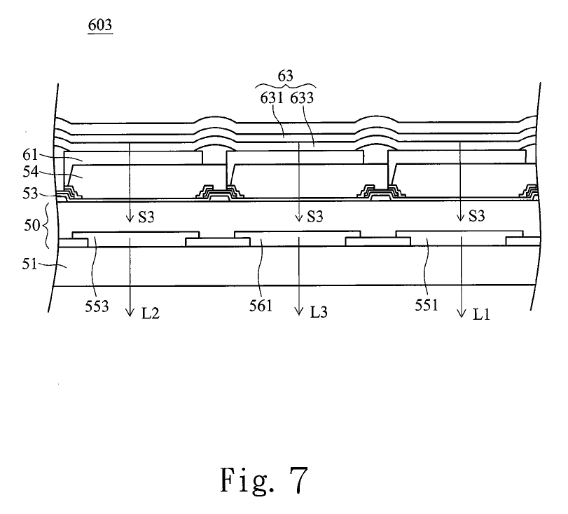

Finally, referring to FIG. 7, it illustrates the cross-section prospective view of another embodiment of the present invention. The active-matrix organic electroluminescent display apparatus 603 of the present invention comprises at least one TFT 53 arranged on the first color filter conversion apparatus 50. The first color filter conversion apparatus 50 arranged on the substrate 51. Moreover, the insulating layer 54 and the first electrode 61 are disposed on the TFT 53 and the first color filter conversion apparatus 50 in sequence. Next, the organic light emitting element 63 is positioned on the first electrode 61 to form a structure of an array on color filter (AOC). The organic light emitting element 63 is arranged by overlapping the first organic light emitting element 631 and the second light emitting element 633 on the vertically extended region of the first photo resist 551, the second photo resist 553, and the color conversion layer 561 of the first color filter conversion apparatus 50. The position for arranging the color conversion layer 561 of the color filter conversion apparatus is exchangeable.

A single pixel of the organic electroluminescent display apparatus 603 comprises the first photo resist 551, the second photo resist 553, and the color conversion layer 561, wherein the first photo resist 551, the second photo resist 553, and the color conversion layer 561 are positioned on sub pixels of the single pixel respectively. The color conversion layer 561 is not limited to be positioned on the sub pixels on two sides of the single pixel. In one embodiment of the present invention, the color conversion layer 561 is arranged on the central sub pixel. Certainly, the positions of the first photo resist 551 and the second photo resist 553 can be changed.

In the embodiment of the present invention, the first organic light emitting element 631 and the second light emitting element 633 are overlapped on the first color filter conversion apparatus 50, which generates the third light source S3. However, the first organic light emitting element 631 and the second light emitting element 633 can also be arranged by mixed evaporation to form a single layer of the organic light emitting element 63 and this also achieves the purpose of producing the third light source S3. For example, the organic light emitting element 63 can be a blue light source or a blue-green light source. Moreover, the organic light emitting element 63 can be selected as a doping organic light emitting layer by doping at least one host emitter (H) with at least one dopant (D). Thus, the third light source S3 is also produced.

In another embodiment of the present invention, a second color filter conversion apparatus are arranged underneath the packing cover (not shown). Thus, a top emission active-matrix organic electroluminescent display apparatus in formed.

In conclusion, the present invention relates to a color filter conversion apparatus. More particularly, the present invention relates to a color filter conversion apparatus and an organic electroluminescent display apparatus thereof. It not only enhances the brightness and color levels, but also simplifies the manufacturing process, and enhances yield rate.

Although the present invention has been described in considerable detail with reference and certain preferred embodiments thereof, other embodiments are possible. Therefore, their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An organic electroluminescent display apparatus, comprising:
a substrate;
a first color filter conversion apparatus, comprising:
at least one color conversion layer, arranged on the substrate; and
at least one first photo resist and at least one second photo resist, arranged on the substrate where no color conversion layer is arranged on;
a first electrode, arranged on the first color filter conversion apparatus;
at least one organic light emitting element, arranged on the first electrode; and
an second electrode, arranged on the organic light emitting element.

2. The organic electroluminescent display apparatus of claim 1, wherein the organic light emitting element comprises a first organic light emitting element and a second organic light emitting element; the first organic light emitting element is disposed on the vertically extended region of the first color photo resist, and the second organic light emitting element is disposed on the vertically extended region of the first photo resist, the second photo resist, and the color conversion layer; the overlap between the first organic light emitting element and the second organic light emitting element is formed on the vertically extended region of the first photo resist; and the positions for disposing the first organic light emitting element and the second organic light emitting element are exchangeable.

3. The organic electroluminescent display apparatus of claim 1, wherein the organic light emitting element comprises a first organic light emitting element and a second organic light emitting element; the second organic light emitting element is disposed on the vertically extended region of the color conversion layer and the second color photo resist, and the first organic light emitting element is disposed on the vertically extended region of the color conversion layer, the first photo resist, and the second photo resist; the overlap between the first organic light emitting element and the second organic light emitting element is formed on the vertically extended region of the color conversion layer and the second photo resist; and the positions for disposing the first organic light emitting element and the second organic light emitting element are exchangeable.

4. The organic electroluminescent display apparatus of claim 1, wherein the organic light emitting element comprises a first organic light emitting element and a second organic light emitting element; the first organic light emitting element and the second organic light emitting element are disposed on the vertically extended region of the color conversion layer, the first color photo resist, and the second color photo resist; and the positions for disposing the first organic light emitting element and the second organic light emitting element are exchangeable.

5. The organic electroluminescent display apparatus of claim 1, wherein the organic light emitting element comprises a first organic light emitting element and a second organic light emitting element; the second organic light emitting element is disposed on the vertically extended region of the color conversion layer and the second color photo resist; and the first organic light emitting element is disposed on the vertically extended region of the first photo resist.

6. The organic electroluminescent display apparatus of claim 1, wherein the organic light emitting element comprises a first organic light emitting element and a second organic light emitting element; the second organic light emitting element is disposed on the vertically extended region of the second color photo resist, and the first organic light emitting element is disposed on the vertically extended region of the color conversion layer and the first photo resist.

7. The organic electroluminescent display apparatus of claim 1 further comprising a packing cover arranged on the substrate to enclose the organic light emitting element; and a second color filter conversion apparatus is arranged underneath the packing cover.

8. The organic electroluminescent display apparatus of claim 1, further comprising at least one thin film transistor arranged on the substrate or on the first color filter conversion apparatus, wherein an insulating layer and the first electrode are disposed on the thin film transistor and the color conversion layer, the first photo resist, and the second photo resist are arranged in the insulating layer while the thin film transistor is arranged on the substrate; the first electrode is arranged on the thin film transistor while the thin film transistor is arranged on the first color filter conversion apparatus.

9. The organic electroluminescent display apparatus of claim 8 further comprising a packing cover arranged on the substrate to enclose the organic light emitting element; and a second color filter conversion apparatusis arranged underneath the packing cover.

10. The organic electroluminescent display apparatus of claim 1, wherein the first color filter conversion apparatus further comprises one of at least one overcoat layer, at least one barrier layer and a combination thereof.

11. The organic electroluminescent display apparatus of claim 1, wherein the first color filter conversion apparatus further comprises at least one black matrix, the black matrix on the substrate.

12. The organic electroluminescent display apparatus of claim 1, wherein a third photo resist is arranged below the color conversion layer.

13. The organic electroluminescent display apparatus of claim 2, wherein the first organic light emitting element and the second light emitting element optionally comprise one of a hole injection layer, a hole transporting layer, an organic light emitting layer, an electron transporting layer, an electron injection layer, and one of the combinations thereof.

14. The organic electroluminescent display apparatus of claim 2, wherein the second organic light emitting element produces a second light source, and the light from the second light source is converted into a third light after transmitting through the color conversion layer; the second light source is filtered to generate a second light after transmitting through the second photo resist; and the overlap between the first organic light emitting element and the second organic light emitting element generates a third light source, and the third light source is filtered to generate a first light after transmitting through the first photo resist.

15. The organic electroluminescent display apparatus of claim 14, wherein the second light source is a green light source, and the third light source is a blue-green light source; the first photo resist and the second photo resist are a blue photo resist and a green photo resist respectively; and the color conversion layer is a color conversion layer that coverts the green light source into a red light source.

16. The organic electroluminescent display apparatus of claim 2, wherein a functional area of the color conversion layer is larger than the functional area of the first photo resist or the second photo resist.

17. The organic electroluminescent display apparatus of claim 2, wherein one of the first organic light emitting element, the second organic light emitting element, and a combinations thereof are constructed of one of a single-layer organic light emitting layer, a multi-layer overlapping organic light emitting layer, and a doping organic light emitting layer.

18. A color filter conversion apparatus, comprising,
a substrate;
at least one color conversion layer, arranged on the substrate; and
at least one first photo resist and at least second photo resist, arranged on the substrate where no the color conversion layer is arranged on.

19. The color filter conversion apparatus of claim 18, wherein at least on black matrix is arranged on the substrate.

20. The color filter conversion apparatus of claim 19, wherein a first electrode is arranged on the color filter conversion apparatus, and a first organic light emitting element is arranged on the vertically extended region of the first photo resist; a second organic light emitting element is arranged on the vertically extended region of the first photo resist, the second photo resist, and the color conversion layer; and a second electrode is arranged on the second organic light emitting element.

21. An organic electroluminescent display apparatus, comprising:
a substrate;
at least one organic light emitting element, arranged on the substrate;
a packing cover, arranged on the substrate, and the packing cover enclosing the organic light emitting element;
a second color filter conversion apparatus, comprising:
at least one color conversion layer, arranged underneath the packing cover; and
at least one first photo resist and at least one second photo resist, arranged on the substrate where no color conversion layer is arranged on;
a first electrode, arranged on the substrate and below the organic light emitting element; and
an second electrode, arranged on the organic light emitting element.

22. The organic electroluminescent display apparatus of claim 21, wherein the organic light emitting element comprises a first organic light emitting element and a second organic light emitting element; the first organic light emitting element is disposed on the vertically extended region of the first photo resist, and the second organic light emitting element is disposed on the vertically extended region of the first photo resist, the second photo resist, and the color conversion layer; the overlap between the first organic light emitting element and the second organic light emitting element is formed on the vertically extended region of the first photo resist; and the area for disposing the first organic light emitting element and the second organic light emitting element are exchangeable.

23. The organic electroluminescent display apparatus of claim 22, wherein at least one thin film transistor is arranged on the substrate; an insulating layer and the first electrode are disposed on the thing film transistor in sequence.
